(19) United States
(12) Patent Application Publication
(10) Pub. No.: US 2020/0047539 A1
(43) Pub. Date: Feb. 13, 2020

(54) Combination Glove and Marking Device

(71) Applicant: Patrick Newsome, Wooddale, IL (US)

(72) Inventor: Patrick Newsome, Wooddale, IL (US)

(21) Appl. No.: 16/101,481

(22) Filed: Aug. 12, 2018

(51) Int. Cl. B43K 23/012; B43K 25/02

(52) U.S. Cl. CPC B43K 23/012; B43K 8/02; B43K 25/026

(57) ABSTRACT

A combination glove and marking device where the marking device is built into the forefinger portion of a glove and the applicator tip extends through an aperture located at the tip of the forefinger of the glove so that a user can mark an item such as a bingo card by simply pressing down with his or her forefinger. In an alternate embodiment, the marking device can be attached to the user's finger by one or more straps. The marking device includes an ink reservoir that is refillable by the user.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of marking devices and more specifically to combination glove and marking device.

Hand held graphic marking devices that use colored ink within a reservoir and a porous ink retaining tip at one end of the reservoir for creating colored drawings or dots are well known.

An example of a marking device can be found in U.S. Pat. No. 5,222,823 issued to Patricia Conforti in June of 1993, now in the public domain. This patent specifically describes a marking device for a game of chance, where a spring biased applicator tip can be pressed down to create a circular dot on a sheet of paper, for example on a printed bingo sheet.

However, there is a deficiency in the prior technology in that the user's hand can become tired of holding the marking device during long periods of game playing. It would therefore be beneficial to have a device that did not require the user to physically hold an independent marking device when playing games of chance.

### BRIEF SUMMARY OF THE INVENTION

The primary object of the invention is to provide a marking device that is built into the finger portion of a glove that allows the user to mark a game sheet by pressing the tip of the forefinger portion of his or her glove onto the sheet.

Another object of the invention is to provide a combination glove and marking device that allows the user to refill an ink reservoir within the marking device when needed.

Another object of the invention is to provide a combination glove and marking device that allows the option to remove the marking device from the glove and attach the marking device to a forefinger by means of one or more straps.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a combination glove and marking device comprising: a hand glove, an elongate ink storage reservoir, a reservoir cap, a porous applicator member, a compression spring, an ink flow control disk, an applicator member enclosure, an applicator cap and liquid ink, said elongate ink storage reservoir being open on both ends, said reservoir cap being removably attached to one end of elongate ink storage reservoir, said applicator enclosure being integrally attached to opposite end of said ink storage reservoir, said compression spring located within said applicator member enclosure and forcing said porous applicator member downward, and said ink flow control disk mounted above said porous member and below said compression spring so that when a user pushes down on said porous applicator member, said spring compresses allowing said liquid ink to flow from said applicator member enclosure to said porous applicator, said marking device stored within the forefinger portion of said glove, said porous applicator member exiting an aperture located at the tip of said forefinger portion of said glove, said porous applicator member capable of being covered by said applicator cap when said applicator is not in use.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention with the applicator facing down.

FIG. 2 is a perspective view of the invention with the applicator cap in place.

FIG. 3 is a side view of the invention with the applicator cap removed.

FIG. 4 is a side section view of the invention.

FIG. 5 is a perspective view of an alternate embodiment of the invention where the marking device is attached to a finger by straps.

FIG. 6 is a side view of the forefinger of a glove with the marking device in place within the glove.

### DETAILED DESCRIPTION OF THE DRAWINGS AND PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

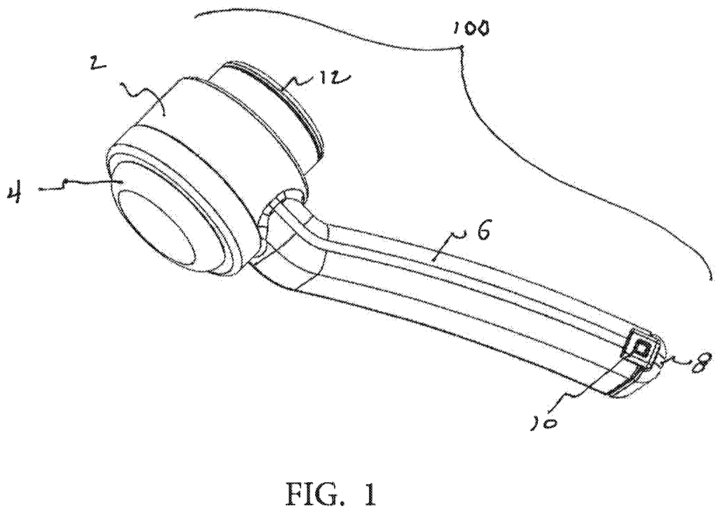

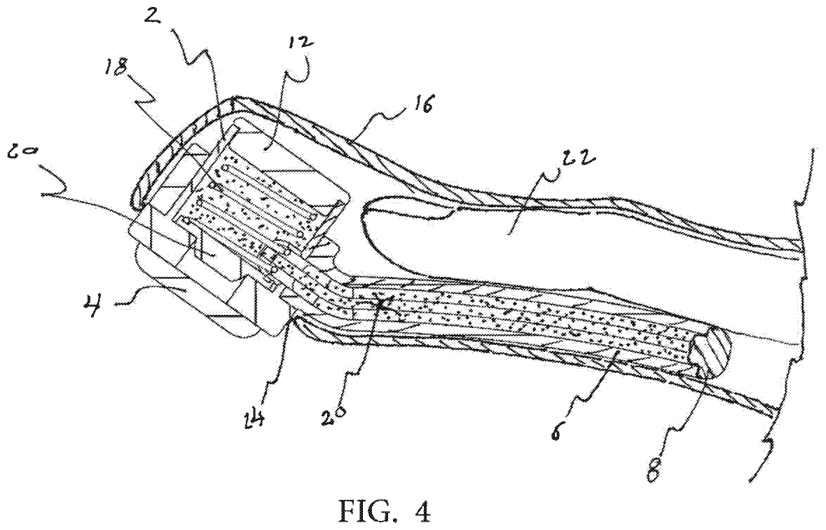

Referring now to FIG. 1 we see a perspective view of the invention 100. an elongate ink storage reservoir 6 is capped at one end in a filler cap 8 and attached at the opposite end to applicator enclosure housing 2. The housing 2 is hollow and cylindrical in shape and covered with a disk member 12. A porous applicator member 4 is located at the lower end of the housing 2. The filler cap 8 is retained by snap tabs 10. Cap 8 is removable for refilling the reservoir 6 with ink 20, shown in the side section view in FIG. 4.

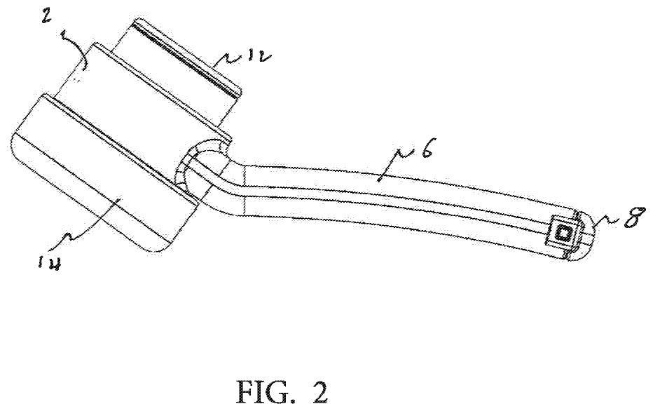

FIG. 2 is a side view of the invention 100 with the applicator cap 14 in place. The cap 14 is used when the device is being stored or shipped.

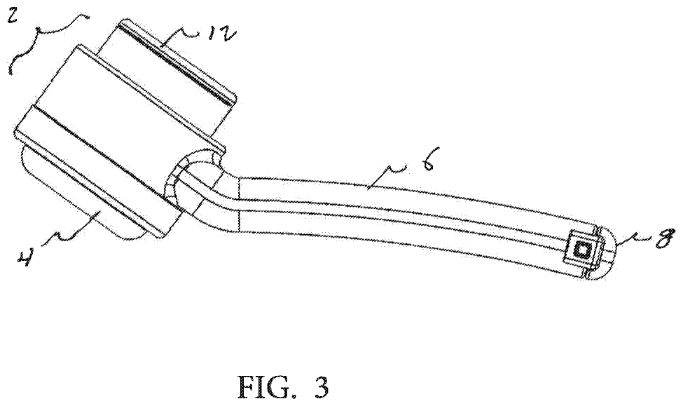

FIG. 3 is a side view of the invention 100 with the applicator cap 14 removed.

FIG. 4 is a side view of the invention which includes the marking device and a hand glove. The forefinger 16 of the glove houses the marking device comprised of the elongate storage reservoir 6 and the applicator housing 2. An aperture 24 in the finger 16 of the glove allows the applicator portion 4 to protrude out of the glove. The user's finger 22 resides just above the storage reservoir 6 and the tip of the finger is located just behind applicator housing 2. Compression spring 18 resides above a flow control disk 20. When the user presses down on applicator tip 4, the flow control disk is lifted up allowing ink 20 to flow into the porous applicator tip 4. When the user lifts up the applicator tip 4, the compression spring 18 pushes the flow control disk 20 down and restricting the amount of ink 20 that can flow into the applicator tip 4. The applicator tip is angled up at an angle of approximately fifteen degrees in relation to the ink storage reservoir 6. This angle makes it ergonomically easier for the user to press down on a sheet of paper while wearing the glove 16.

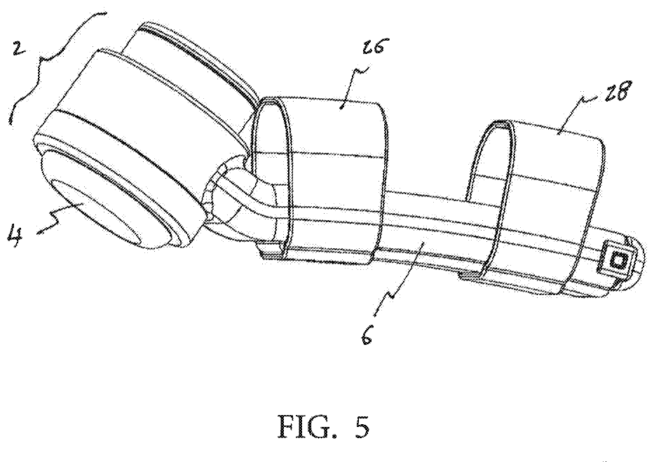

FIG. 5 is a side perspective view of an alternate embodiment of the invention where straps 26, 28 can be used to secure a fore finger so that the invention can be used without a glove 16.

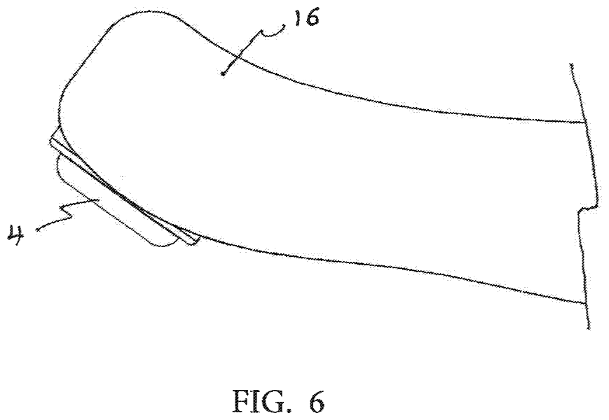

FIG. 6 is a side view of the forefinger portion of a glove 16 with an applicator tip 4 penetrating out from the tip of the glove 16 ready to be used for marking a sheet such as the printed paper sheets used for bingo games or the like.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. combination glove and marking device comprising:
a hand glove
an elongate ink storage reservoir;
a reservoir cap;
a porous applicator member;
a compression spring;
an ink flow control disk;
an applicator member enclosure;
an applicator cap;
liquid ink;
said elongate ink storage reservoir being open on both ends;
said reservoir cap being removably attached to one end of elongate ink storage reservoir;
said applicator enclosure being integrally attached to opposite end of said ink storage reservoir;
said compression spring located within said applicator member enclosure and forcing said porous applicator member downward; and
said ink flow control disk mounted above said porous member and below said compression spring so that when a user pushes down on said porous applicator member, said spring compresses allowing said liquid ink to flow from said applicator member enclosure to said porous applicator;
said marking device stored within the forefinger portion of said glove;
said porous applicator member exiting an aperture located at the tip of said forefinger portion of said glove;
said porous applicator member capable of being covered by said applicator cap when said applicator is not in use.

2. A combination glove and marking device as claimed in claim 1 wherein said applicator member is angled upwards at approximately fifteen degrees with respect to the plain of said elongate ink storage reservoir.

3. A combination glove and marking device as claimed in claim 1 wherein an alternate embodiment, one or more straps surround said elongate ink reservoir and said user's fore finger enabling said marking device to be used without the need of said glove.
